(19) United States
(12) Patent Application Publication
(10) Pub. No.: US 2013/0100681 A1
(43) Pub. Date: Apr. 25, 2013

(54) LED LAMP

(71) Applicants: Tsun-Yu Huang, Changhua County (TW); Cheng-Yi Huang, Changhua County (TW)

(72) Inventors: Tsun-Yu Huang, Changhua County (TW); Cheng-Yi Huang, Changhua County (TW)

(21) Appl. No.: 13/281,268

(22) Filed: Oct. 25, 2011

(51) Int. Cl. F21V 19/00; F21V 29/00

(52) U.S. Cl. 362/373; 362/382

(57) ABSTRACT

A LED lamp of the present invention includes a lamp holder, a LED device, and a heating member. The lamp holder includes a base and a power supply. The power supply is disposed on the base. The LED device is disposed on the base and connected to the power supply electrically. The heating member is connected to the power supply electrically. When the light is emitted out of the LED lamp of the present invention, the LED lamp can achieve high heating efficiency at the same time.

### BACKGROUND OF THE INVENTION

1. Field of the Invention

The present invention relates to a lamp, more particularly to a LED device that is functioned as a luminous body for a LED lamp.

2. Description of the Prior Art

Conventional essential oil lamps generally have luminous bodies made of tungsten filaments, such as incandescent lamps, halogen lamps, and fluorescent lamps etc. However, there are many problems about the tungsten filament lamps, such as consuming much electrical power, generating high heating, splitting easily, and the filaments are easy to be melted down so as to shorten their life. In addition, the fluorescent lamps have some poisonous chemical materials, such as mercury, that may pollute the environment and harm the people. Due to LEDs have many excellent characteristics, such as, high luminance, long life, broken difficultly, consuming less electrical power, environmental protection, and small volume etc, so that there are many kinds of essential oil lamps use LEDs instead of tungsten filaments in the market. LEDs have been the most potential light sources in these years.

The essential oil in the lamps must be heated up to a predetermined temperature so that the essential oil may vaporize to the air efficiently. However, because the heating of the LEDs are low so that the essential oil may not vaporize efficiently that cause the essential oil lamps to lose many functions, such as improving the environment, cleaning up the air, avoiding the germs attacking users, stabilizing users' emotion, and keeping up users' spirits etc.

Moreover, conventional essential oil lamps have to additionally dispose a heat-conductive element conducting weak thermal energy of the LED to a container, which contains the essential oil. However, the thermal energy almost spread to the air in the conducting process so that the essential oil may not vaporize efficiently.

### SUMMARY OF THE INVENTION

The main object of the present invention is to provide a LED lamp which has high heating efficiency.

To achieve the above, a LED lamp of the present invention comprises a lamp holder, a LED device, and a heating member.

The lamp holder comprises a base and a power supply. The power supply is disposed on the base.

The LED device is disposed on the base. The LED device is connected to the power supply electrically.

The heating member is disposed on the LED device. The heating member is connected to the power supply electrically.

Due to the heating member is direct disposed on the LED device, the combination of the heating member and the LED device can emit light and heat direct. When the light is emitted out of the LED lamp of the present invention, the LED lamp can achieve high heating efficiency at the same time.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a side view in accordance with the first embodiment of the present invention;

FIG. 2 is a stereogram in accordance with the second embodiment of the present invention;

FIG. 3 is a schematic drawing showing the inserting portion rotating with respect to the pressing portion of the second embodiment of the present invention;

FIG. 4 is a side view in accordance with the third embodiment of the present invention;

FIG. 5 is a side view in accordance with the fourth embodiment of the present invention;

FIG. 6 is a side view in accordance with the fifth embodiment of the present invention;

FIG. 7 is a side view in accordance with the sixth embodiment of the present invention;

FIG. 8 is a side view in accordance with the seventh embodiment of the present invention;

FIG. 9 is a stereogram in accordance with the seventh embodiment of the present invention;

FIG. 10 is a stereogram in accordance with the eighth embodiment of the present invention;

### DETAILED DESCRIPTION OF THE PREFERRED EMBODIMENTS

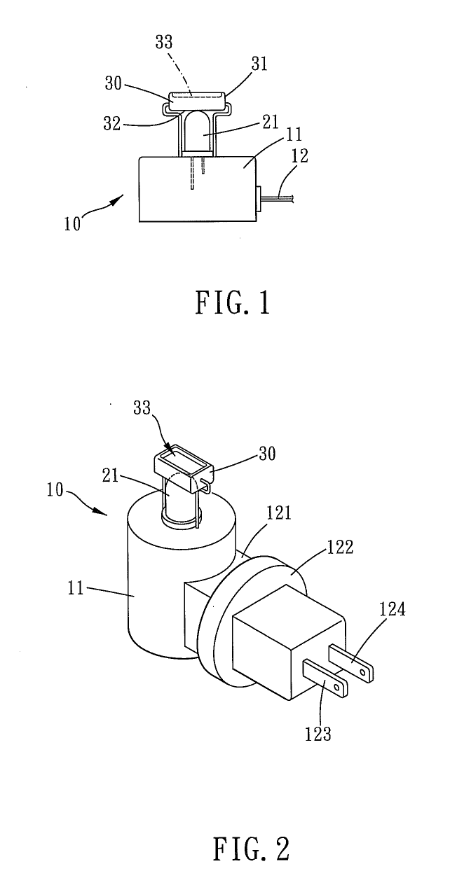

Please refer to FIG. 1, in the first embodiment of the present invention, the LED lamp comprises a lamp holder 10, a LED device and a heating member 30.

The lamp holder 10 comprises a base 11 and a power supply 12. The power supply 12 is disposed on the base 11. In this embodiment, the power supply 12 is a power cord which is connected to an outer power source.

The LED device is disposed on the base 11. The LED device is connected to the power supply 12 electrically. In this embodiment, the LED device comprises at least a LED luminous body 21.

The heating member 30 is disposed on the LED device. The heating member 30 is connected to the power supply 12 electrically. The heating member 30 is attached to the LED device by adhesive. In this embodiment, the heating member 30 is disposed on a top of the LED luminous body 21. Preferably, the heating member 30 includes a top 31 and a bottom 32. The top 31 of the heating member 30 is formed with a receiving groove 33. The bottom 32 of the heating member 30 is attached to the top of the LED luminous body 21 by adhesive. The receiving groove 33 can contain liquid or an absorbent member absorbing the liquid therein (not shown). More definitely, the heating member 30 of the present invention is a cement resistor, and the liquid is essential oil.

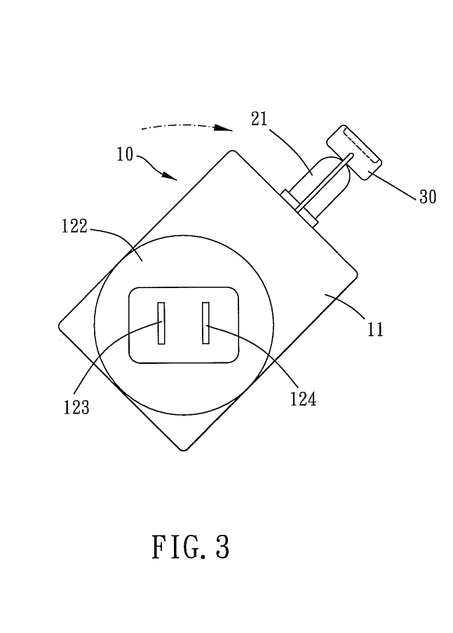

Please refer to FIG. 2 and FIG. 3, in the second embodiment of the present invention, the power supply 12 is a plug which includes a pressing portion 121 and an inserting portion 122. The pressing portion 121 is disposed on the base 11. The pressing portion 121 comprises two inserting holes, a conductive strip, and an abutting strip (not shown). The conductive strip and the abutting strip are inserted to one of the inserting holes respectively. The inserting portion 122 is rotatably disposed on the pressing portion 121. The inserting portion 122 comprises a first pin 123 and a second pin 124. The inserting portion 122 is formed with two penetrating holes (not shown. The first pin 123 and the second pin 124 are inserted to one of the penetrating holes respectively. One end of the first pin 123 is abutted to the conductive strip. One end of the second pin 124 is abutted to the abutting strip. Thereby when the LED lamp of the present invention insert to a socket, the base's angle can be adjusted that depends on the users, as shown in FIG. 3.

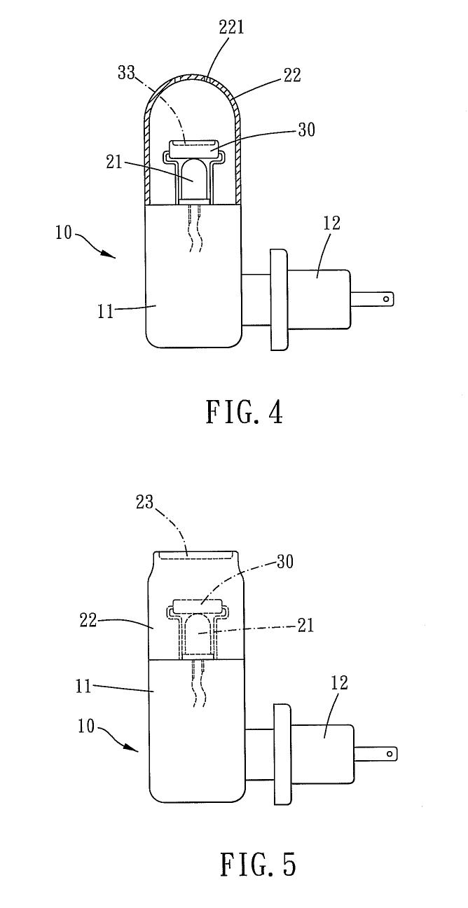

Please refer to FIG. 4, in the third embodiment, the LED lamp further comprises a lamp cover 22 which is detachably disposed on the base 11. The lamp cover 22 covers the LED luminous body 21 therein. The lamp cover 22 is formed with at least a vent 221. Thereby the light of the luminous body can go through the vent to outside of the lamp cover 22 so as to enhance a light emitting effect and build a soft atmosphere. Moreover, the essential oil can also go through the vent and spread to outside of the lamp cover 22.

Please refer to FIG. 5, in the forth embodiment of the present invention, the LED lamp comprises a lamp cover 22 which is detachably disposed on the base 11. The lamp cover 22 covers the LED luminous body 21 therein. The lamp cover 22 is formed with a liquid-receiving groove 23 which is located on a top of an outer surface of the lamp cover 22. The liquid-receiving groove 23 can contain liquid or an absorbent member absorbing the liquid therein (not shown). Due to the present embodiment has disposed the liquid-receiving groove 23, the heating member 30 may have the receiving groove or not. Furthermore, the lamp cover 22 is composed of a heat-conductive material, such as ceramics, and so is the container. Or a top of the lamp cover 22 is formed with plural vents. Thereby the thermal energy of the heating member can be concentrated in the lamp cover so as not to spread to the air. Furthermore, the thermal energy can be conducted to the container by the lamp cover so as to enhance the evaporation rate of the essential oil.

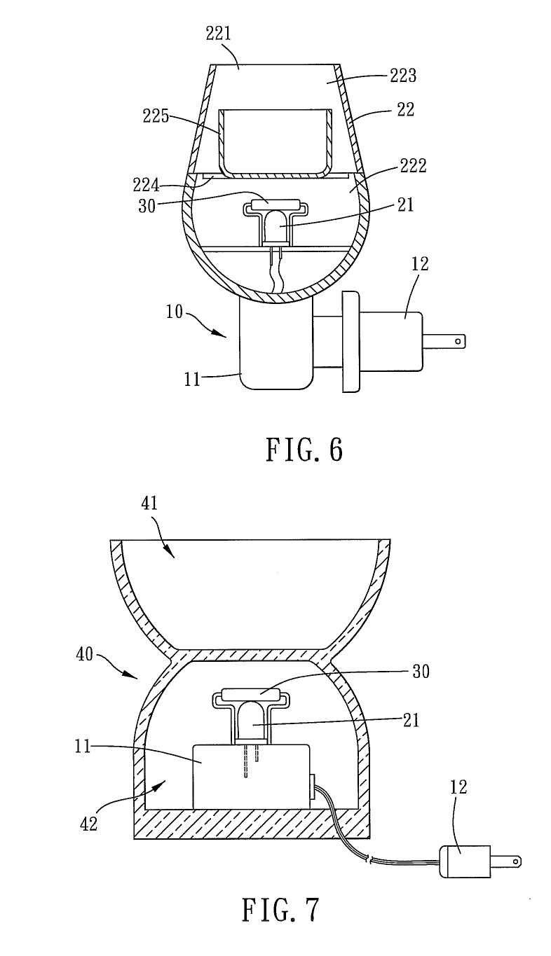

Please refer to FIG. 6, in the fifth embodiment, the lamp cover 22 is formed with a first space 222 and a second space 223. The lamp cover 22 comprises a platform 224 and a container 225. The platform 224 is disposed between the first space 222 and the second space 223. The container 225 disposed on the platform 224 is located in the second space 223. The LED luminous body 21 is located in the first space 222. The lamp cover 22 is formed with at least a vent 221. The container 225 can contain liquid or an absorbent member absorbing the liquid therein (not shown). The liquid is essential oil. Furthermore, the platform 22 is composed of a heat-conductive material, such as ceramics. The material of the lamp is not restricted. Or the platform is formed with few opening hole. Thereby the thermal energy of the heating member can be more concentratedly conducted to the container by the platform so as to enhance the evaporation rate of the essential oil.

Please refer to FIG. 7, in the sixth embodiment, the LED lamp further includes a stand 40. The stand 40 is formed with a liquid-receiving groove 41 and a holding space 42. The liquid-receiving groove 41 is located above the holding space 42. The base 11 is disposed in the holding space 42. The holding space 42 is formed with at least an opening. The liquid-receiving groove 41 can contain liquid or an absorbent member absorbing the liquid therein (not shown). The liquid is essential oil. Due to the present embodiment has disposed the liquid-receiving groove 23, the heating member 30 may have the receiving groove or not. Furthermore, the stand 40 is composed of a heat-conductive material, such as ceramics. Thereby the light of the LED device can go through the opening to outside of the stand 40. The thermal energy of the heating member can be conducted indirectly to the essential oil of the liquid-receiving groove so as to enhance the evaporation rate of the essential oil.

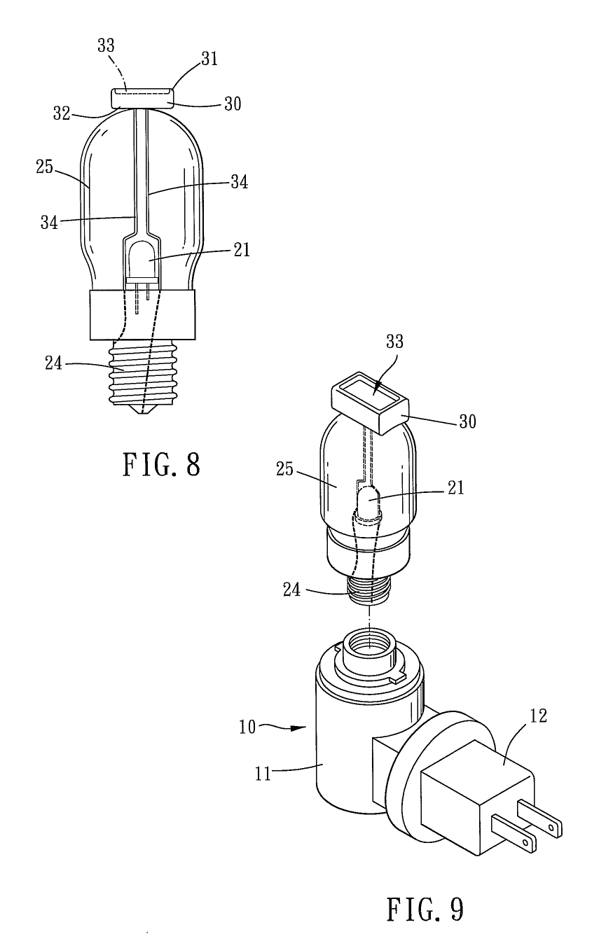

Please refer to FIG. 8 and FIG. 9, in the seventh embodiment, the LED device comprises a LED bulb. The LED bulb comprises a LED luminous body 21, a connecting portion 24 and a housing 25. The LED luminous body 21 is connected to the connecting portion 24 electrically. The housing 25 disposed on the connecting portion 24 covers the LED luminous body 21 therein. The connecting portion 24 is threaded on the base 11, as shown in FIG. 9. The heating member 30 is disposed on a top of an outer surface of the housing 25. Preferably, the bottom 32 of the heating member is attached to the top of the outside of the housing 25 by adhesive. The heating member 30 comprises two connectors 34. The connectors 34 penetrate the housing 25 and are connected to the connecting portion 24. Thereby it can avoid both connectors being exposed to the air which would make both connectors be oxidized or corroded so that the life of both connectors may be shortened. Furthermore, the whole appearance of the present invention would not be spoiled.

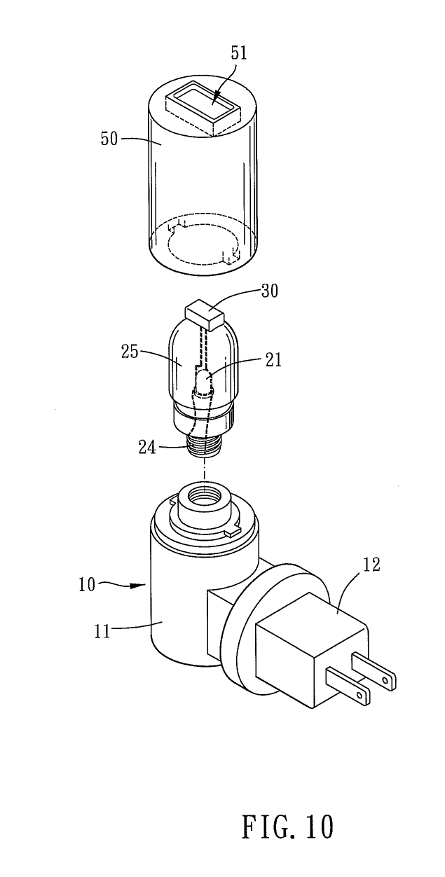

Please refer to FIG. 10, in the eighth embodiment, the LED lamp further comprises a lamp cover 50. The lamp cover 50 detachably disposed on the base 11 covers the LED device therein. The lamp cover 50 comprises a receiving groove 51. The receiving groove 51 is disposed on a top of an outer surface of the lamp cover 50.

To conclude, when the light is emitted out of the LED lamp of the present invention, the LED lamp can achieve high heating efficiency at the same time. After the heating member heats up, the essential oil of the receiving groove can absorb a great deal of thermal energy so as to achieve to enhance the evaporation rate of the essential oil. In other embodiments, the heating member cannot have that receiving groove as well. In those embodiments, the LED lamp can indirectly concentrate the thermal energy by the lamp which can prevent the thermal energy from spreading to the air. Thereby the essential oil may still absorb the thermal energy that is generated by the heating member so as to enhance the evaporation rate of the essential oil.

What is claimed is:

1. A LED lamp comprising:
a lamp holder, comprising a base and a power supply, the power supply being disposed on the base;
a LED device, being disposed on the base, the LED device being connected to the power supply electrically;
a heating member, being disposed on the LED device, the heating member being connected to the power supply electrically.

2. The LED lamp of claim 1, wherein the LED device comprises at least a LED luminous body, the heating member is disposed on a top of the LED luminous body.

3. The LED lamp of claim 2, wherein the heating member comprises a top, the top of the heating member is formed with a receiving groove.

4. The LED lamp of claim 3, wherein the LED lamp further comprises a lamp cover, the lamp cover is detachably disposed on the base, the lamp cover covers the LED luminous body therein, the lamp cover is formed with at least a vent.

5. The LED lamp of claim 2, wherein the LED lamp further comprises a lamp cover, the lamp cover is detachably disposed on the base, the lamp cover covers the LED luminous body therein, the lamp cover is formed with a liquid-receiving groove, the liquid-receiving groove is located on a top of an outer surface of the lamp cover.

6. The LED lamp of claim 2, wherein the LED lamp further comprises a lamp cover, the lamp cover is formed with a first space and a second space, the lamp cover comprises a platform and a container, the platform is disposed between the first space and the second space, the container is disposed on the platform, the container is located in the second space, the LED luminous body is located in the first space, the lamp cover is formed with at least a vent.

7. The LED lamp of claim 2, wherein the LED lamp further comprises a stand, the stand is formed with a liquid-receiving groove and a holding space, the liquid-receiving groove is located above the holding space, the base is disposed in the holding space, the holding space is formed with at least an opening.

8. The LED lamp of claim 1, wherein the LED device comprises a LED bulb, the LED bulb comprises at least a LED luminous body, a connecting portion and a housing, the LED luminous body is connected to the connecting portion electrically, the housing is disposed on the connecting portion, the housing covers the LED luminous body therein, the connecting portion is threaded on the base, the heating member is disposed on a top of an outer surface of the housing.

9. The LED lamp of claim 8, wherein the heating member comprises a top, the top of the heating member is formed with a receiving groove.

10. The LED lamp of claim 9, wherein the heating member comprises two connectors, the connectors penetrate the housing, the connectors are connected to the connecting portion.

11. The LED lamp of claim 8, wherein the heating member comprises two connectors, the connectors penetrate the housing, the connectors are connected to the connecting portion.

12. The LED lamp of claim 8, wherein the LED lamp further comprises a lamp cover, the lamp cover is detachably disposed on the base, the lamp cover covers the LED device therein, the lamp cover comprises a receiving groove, the receiving groove is disposed on a top of an outer surface of the lamp cover.

13. The LED lamp of claim 1, wherein the power supply comprises a pressing portion and an inserting portion, the pressing portion is disposed on the base, the pressing portion comprises two inserting holes, a conductive strip, and an abutting strip, the conductive strip and the abutting strip are inserted to one of the inserting holes respectively, the inserting portion is rotatably disposed on the pressing portion, the inserting portion comprises a first pin and a second pin, the inserting portion is formed with two penetrating holes, the first pin and the second pin are inserted to one of the penetrating holes respectively, one end of the first pin is abutted to the conductive strip, one end of the second pin is abutted to the abutting strip.

14. The LED lamp of claim 13, wherein the heating member is attached to the LED device by adhesive.

15. The LED lamp of claim 1, wherein the heating member is attached to the LED device by adhesive.
